(19) United States
(12) Patent Application Publication
(10) Pub. No.: US 2022/0024683 A1
(43) Pub. Date: Jan. 27, 2022

(54) METHOD FOR CONTROLLING A BEVERAGE BREWING PROCESS AND PRODUCT PACKAGE WITH SELECTIVE BREWING CONTROL

(71) Applicant: Rich Products Corporation, Buffalo, NY (US)

(72) Inventors: Ralf Reiser, Orchard Park, NY (US); Shawn Campbell, Burlington (CA); Seung-Yeol Hong, Amherst, NY (US); Michael Piatko, West Seneca, NY (US)

(21) Appl. No.: 17/285,043

(22) PCT Filed: Oct. 15, 2019
(86) PCT No.: PCT/US2019/056288

§ 371 Date: Apr. 13, 2021

Related U.S. Application Data
(60) Provisional application No. 62/745,847, filed on Oct. 15, 2018.

(51) Int. Cl. B65D 85/804; B65D 81/32; A47J 31/00; B65B 29/02

(52) U.S. Cl. CPC B65D 85/804; B65B 29/02; A47J 31/005; B65D 81/32

(57) ABSTRACT

A product package includes a first volume at least partially filled with a liquid diluent, a second volume containing a brewing material, and a valve configured to selectively fluidly communicate the first volume with the second volume to expose the brewing material to the liquid diluent.

### CROSS-REFERENCE TO RELATED APPLICATIONS

This application claims priority to co-pending U.S. Provisional Patent Application No. 62/745,847 filed on Oct. 15, 2018, the entire content of which is incorporated herein by reference.

### BACKGROUND OF THE DISCLOSURE

The present disclosure relates to systems and methods for controlling a brewing process, and more particularly to systems and method for controlling a beverage brewing process within a sealed, disposable package.

Brewed beverages, such as coffee or tea, are made by exposing brewing material (e.g., coffee grounds, tea leaves, and the like) to water. The water extracts compounds and flavors from the brewing material over time. The amount of time required to produce the final brewed beverage having a desired strength and flavor (i.e. “optimum brew time”) typically varies based at least in part upon the temperature of the water. By way of example, in the case of coffee, the optimum brew time when using hot water can be relatively short (e.g., 3-4 minutes), while the optimum brew time when using cold or room temperature water can be relatively long (e.g., 10-24 hours). In either case, leaving the water in contact with the ground coffee, tea leaves, or other brewing material longer than the optimum brew time can cause undesirable beverage characteristics (e.g., bitterness) and deterioration of quality due to over-extraction.

Because of the time-sensitive nature of brewing beverages, brewed beverage manufacturers typically brew the beverage at a manufacturing facility, and then ship the completed and packaged beverage without the coffee grounds, tea leaves, or other brewing material. To maintain freshness, the brewed beverage is often refrigerated during shipping. This adds expense to the shipping process. In addition, because of the long optimum brew time for certain brewed beverages, a large amount of storage space is required at manufacturing and/or storage facilities for housing such brewed beverages.

### SUMMARY OF THE DISCLOSURE

The present disclosure provides, in one aspect, a product package including a first volume at least partially filled with a liquid diluent, a second volume containing a brewing material, and a valve configured to selectively fluidly communicate the first volume with the second volume to expose the brewing material to the liquid diluent.

The present disclosure provides, in another aspect, a method of controlling a brewing process within a product package. The method includes packaging a liquid diluent in a first volume of a package, packaging a brewing material in a second volume of the package blocked from fluid communication with the first volume, thereafter establishing fluid communication between the first volume and the second volume to expose the brewing material to the diluent; brewing a beverage by exposing the brewing material to the diluent; and then dispensing the brewed beverage from the package. In some embodiments the method includes blocking fluid communication between the first and second volumes after brewing the beverage for a period of time to thereby interrupt the brewing process.

In some embodiments, a method of controlling a brewing process within a product package is provided, and comprises packaging a liquid diluent and a brewing material in a package; exposing the brewing material to the diluent; brewing a beverage by exposing the brewing material to the diluent; and lowering a temperature of the packaging below a freezing temperature of the diluent after a period of time to thereby interrupt the brewing process.

Other features and aspects of the disclosure will become apparent by consideration of the following detailed description and accompanying drawings.

### BRIEF DESCRIPTION OF THE DRAWINGS

FIG. 1 is a perspective view of a product package with selective brewing control according to one embodiment of the present disclosure.

FIG. 2 is a perspective view of a cartridge assembly of the package of FIG. 1.

FIG. 3 is another perspective view of the cartridge assembly of FIG. 2.

FIG. 4A is a top view of the cartridge assembly of FIG. 2, illustrated in a closed configuration.

FIG. 4B is a side schematic representation of the cartridge assembly of FIG. 4A.

FIG. 5A is a top view of the cartridge assembly of FIG. 2, illustrated in a brewing configuration.

FIG. 5B is a side schematic representation of the cartridge assembly of FIG. 5A.

FIG. 6 is a perspective view of a product package with selective brewing control according to another embodiment.

FIG. 7 illustrates the product package of FIG. 6 in an upright position.

FIG. 8 illustrates the product package of FIG. 6 in an inverted position.

FIG. 9 is a perspective view of a product package with selective brewing control according to another embodiment.

FIG. 10 illustrates a method for controlling a beverage brewing process according to one embodiment of the disclosure.

Before any embodiments of the disclosure are explained in detail, it is to be understood that the disclosure is not limited in its application to the details of construction and the arrangement of components set forth in the following description or illustrated in the accompanying drawings. The disclosure is capable of other embodiments and of being practiced or of being carried out in various ways. Also, it is to be understood that the phraseology and terminology used herein is for the purpose of description and should not be regarded as limiting.

### DETAILED DESCRIPTION

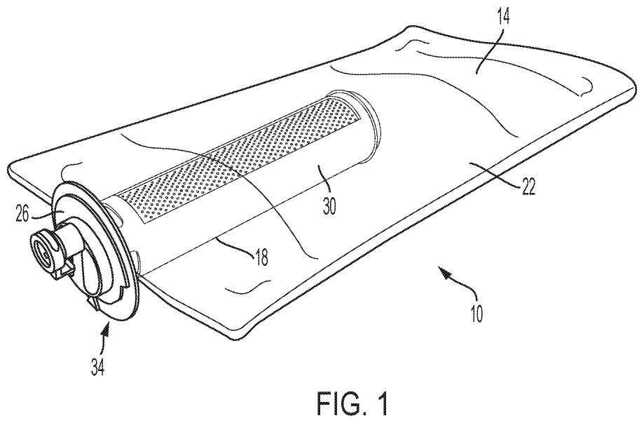

FIG. 1 illustrates a beverage product package 10 for a brewed beverage product that allows the product to be brewed or steeped within the package 10. In particular, the package 10 includes a first volume 14 containing a diluent (e.g., water, flavoring compounds, juice, milk, or the like) and a cartridge assembly 18 at least partially received within the first volume 14. In the illustrated embodiment, the first volume is defined by a bag or pouch 22, made of any suitable food-safe material, such as polyethylene, polypropylene, metal foil, or the like. In other embodiments, the package 10 may include a rigid container defining the first volume 14. In yet other embodiments, the pouch 22 may be received within a second, rigid container (e.g., a bag-in-box arrangement). In some embodiments, all or a portion of the pouch 22 is transparent or translucent, such that the contents can be seen from the exterior of the pouch 22. In other embodiments, the pouch 22 may be opaque.

With reference to FIGS. 2-5B, the cartridge assembly 18 includes an inner housing 26 containing brewing material, such as ground coffee, tea leaves, botanicals, or the like, and an outer housing 30 surrounding the inner housing 26. The inner housing 26 and the outer housing 30 each have an elongated and generally cylindrical shape in the illustrated embodiment, and the inner housing 26 is arranged concentrically within the outer housing 30. The shape of the inner and/or outer housings 26, 30 may vary in other embodiments. The cartridge assembly 18 also includes a working end 34 that protrudes from the pouch 22.

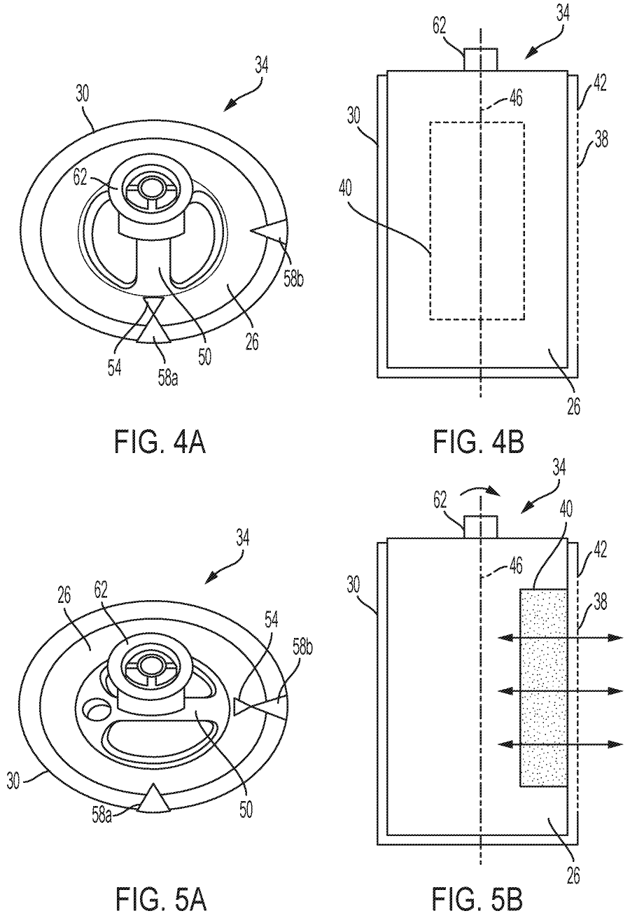

The inner housing 26 of the illustrated cartridge assembly 18 is rotatable relative to the outer housing 30 between a brewing position (FIG. 5B), in which an opening 40 in the inner housing 26 is aligned with a window 42 in the outer housing 30, and a closed position (FIG. 4B) in which the opening 40 in the inner housing 26 is misaligned with respect to the window 42. The inner housing 26 and the outer housing 30 thus act as a valve to selectively expose the brewing material contained within the inner housing 26 to the surrounding diluent liquid contained within the first volume 14 of the package 10. The diluent liquid can then extract compounds and flavors from the brewing material by diffusion as long as the inner housing 26 is in the brewing position. Once an appropriate amount of time has passed for proper brewing, the inner housing 26 can be returned to the closed position to prevent over-extraction of the brewing material. After brewing, the first volume 14 contains a brewed beverage product solution that may be ready to dispense or serve from the package 10.

In the illustrated embodiment, a perforated screen 38 covers the window 42, which acts as a filter to inhibit particles of the brewing material from escaping the inner housing 26. In some embodiments, the screen 38 may be coupled for co-rotation with the inner housing 26. In other embodiments, the screen 38 may be fixed to the outer housing 30. The cartridge assembly 18 may additionally or alternatively include other filter media (e.g., a paper or mesh filter element; not shown) in the inner housing 26 (e.g., behind the screen 38), the outer housing 30 (e.g., over the window 42), and/or surrounding the entirety of the cartridge assembly 18 to prevent particles of the brewing material larger than a screen size of the filter media from dispersing into the first volume 14 containing the liquid diluent.

In the illustrated embodiment, the inner housing 26 is rotatable about a longitudinal axis 46 of the cartridge assembly 18, which in the illustrated embodiment extends centrally through the inner and outer housings 26, 30 along the length of the cartridge assembly 18. In other embodiments, the inner housing 26 may be translatable relative to the outer housing 30 to align and/or misalign the window 42 with respect to the inner housing 26 to define the brewing position and the closed position. Alternatively, the cartridge assembly 18 may include other manners (including valves, rupturable or frangible membranes, etc.) for establishing selective fluid communication between the brewing material and the diluent in the first volume 14.

As also shown in the illustrated embodiment, an actuator 50 is provided on the inner housing 26 at the working end 34 of the cartridge assembly 18. As such, the actuator 50 is accessible from outside the beverage package 10 (FIG. 1) and is graspable to facilitate rotating the inner housing 26 between the closed position (FIGS. 4A-B) and the brewing position (FIGS. 5A-B). An indicator 54 (e.g., an arrow) on the working end 34 of the inner housing 26 is alignable with indicia 58a, 58b (e.g., corresponding arrows) on the outer housing 30 to indicate to the user whether the inner housing 26 is in the brewing position or the closed position. Other indicia (e.g., labels, colors, or the like) may also or alternatively be provided to indicate the relative position of the inner housing 26, and can be at any other suitable locations visible by a user.

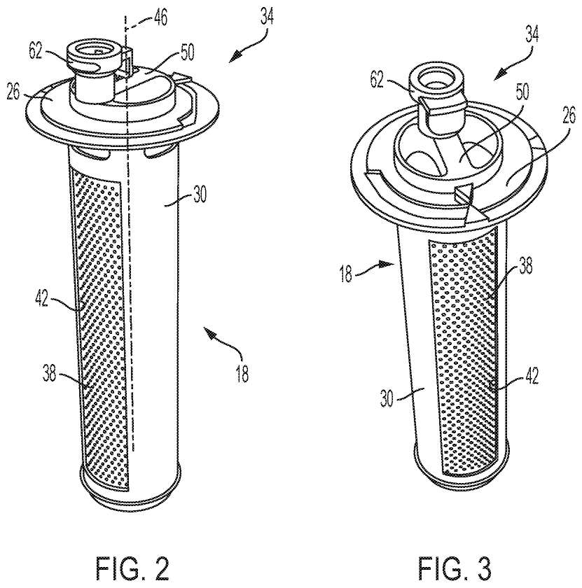

Referring to FIGS. 2 and 3, the illustrated cartridge assembly 18 also includes a quick-connect fitting 62. The quick-connect fitting 62 is in fluid communication with the first volume 14 of the package 10. As such, after brewing, the quick-connect fitting 62 may be coupled to a dispenser to dispense the brewed product solution from the first volume 14. The quick-connect fitting 62 may also be used to fill the first volume 14 with the diluent liquid during manufacture of the product package 10.

In use, the inner housing 18 is filled with brewing material and the first volume of the package is filled with liquid diluent (and optionally other additives such as milk, creamers, flavors, etc., which may collectively be considered part of the liquid diluent). When it is desired to begin brewing, the inner housing 18 is rotated from the closed position to the brewing position, thus aligning the perforations 26 with the window 30 and exposing the brewing material to the surrounding diluent liquid in the first volume 14. The brewing material brews or steeps for a desired time period (e.g., 10-24 hours) until the package 10 contains a brewed beverage solution with a desired strength and flavor. A time period of 10-24 hours may be particularly desirable for brewing coffee (e.g., cold-brew coffee). It should be understood, however, that the desired time period may vary depending on the diluent, the brewing material, and the desired strength or other properties of the brewed beverage solution. In some embodiments, the time period may be less than 10 hours, or the time period may be more than 24 hours. The user can then return the inner housing 26 to the closed position to prevent over-extraction and bitterness. The package 10 can then be stored for an extended period of time without compromising the flavor of the beverage.

Although the first volume 14 in the illustrated embodiment is described as housing coffee grounds, tea leaves, or other brewing material, and whereas a second volume defined around the first volume (and defined between the pouch 22 and the cartridge assembly 18) is described as housing diluent, it will be appreciated that the locations of the brewing material and the diluent can be reversed in any of the embodiments described and/or illustrated herein.

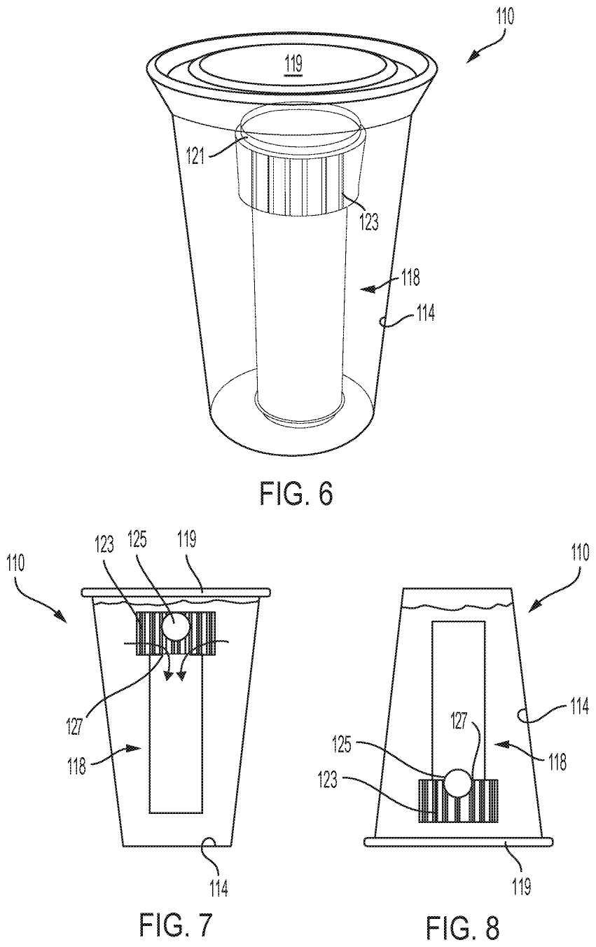

FIGS. 6-8 illustrate a beverage product package 110 according to another embodiment. Like the package 10 described above with reference to FIGS. 1-5B, the package 110 allows a brewed beverage product to be brewed or steeped within the package 110. Features and elements of the package 110 corresponding with features and elements of the package 10 are given like reference numbers plus ‘100,’ and the following description focuses primarily on differences between the package 110 and the package 10 for the sake of brevity.

The package 110 is configured to selectively expose brewing material contained within the cartridge assembly 118 to the diluent liquid in the first volume 114 by changing the orientation of the container 110 from an inverted position (FIG. 8) to an upright position (FIG. 7). Because no actuator is required for this operation, the cartridge assembly 118 need not be accessible from the exterior of the package 110, and in the illustrated embodiment, the cartridge assembly 118 is fully enclosed within the first volume 114 by a lid 119. An end 121 of the cartridge assembly 118 adjacent the lid 119 includes openings 123 (FIG. 6), and the cartridge assembly 118 includes a buoyant internal valve member 125 (FIGS. 7-8) in communication with the openings 123. When the package 110 is moved from the inverted position, the valve member 125 floats away from a valve seat 127 to allow the diluent liquid to flow into the cartridge assembly 118 and into contact with the brewing material. In other embodiments, the valve member 125 may be omitted. In such embodiments, the first volume 114 may be only partially filled with the diluent liquid, such that the level of liquid is below the openings 123 when the package 110 is in the upright position.

In use, when it is desired to begin brewing, the package 110 is rotated from the inverted position (FIG. 8) to the upright position (FIG. 7), which allows the liquid diluent to enter the cartridge assembly 118 and exposes the brewing material to the surrounding diluent. The brewing material brews or steeps for a desired time period (e.g., 10-24 hours) until the package 110 contains a brewed beverage solution with a desired strength and flavor. The user may then open the lid 119 and consume the brewed product from the package 110. Alternatively, the user may return the package 110 to the inverted position to prevent over-extraction and bitterness. The package 110 can then be stored for an extended period of time without compromising the flavor of the beverage. The illustrated package 110 may be particularly advantageous when it is desired to start or stop brewing within multiple packages 110 at the same time. For example, a plurality of packages 110 may be assembled together in a box or other container, and the entire container flipped over to begin brewing in each of the packages 110, without having to manipulate the packages 110 individually. The entire container can then be flipped back over to stop brewing.

Although the valve member 125 in the illustrated embodiment of FIGS. 6-8 floats with respect to the diluent (as described above), it will be appreciated that in other embodiments, the valve member can instead be selected to be more dense than the diluent, so that the valve member instead sinks. Using this type of valve, the valve could have an open position when the package 110 is in the orientation shown in FIG. 8, and can have a closed position when the package 110 is in the orientation shown in FIGS. 6-7.

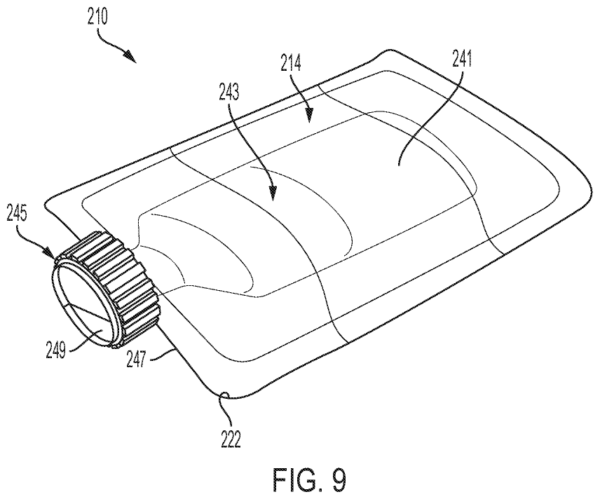

FIG. 9 illustrates a beverage product package 210 according to another embodiment. Like the package 10 described above with reference to FIGS. 1-5B, the package 210 allows a brewed beverage product to be brewed or steeped within the package 210. Features and elements of the package 210 corresponding with features and elements of the package 10 are given like reference numbers plus ‘200,’ and the following description focuses primarily on differences between the package 210 and the package 10 for the sake of brevity.

The package 210 illustrated in FIG. 9 replaces the cartridge assembly 18 with an internal pouch 241 disposed within the outer pouch 222. The first volume 214 is therefore defined by the outer pouch 222, and the internal pouch 241 includes a second volume 243 that contains the brewing material. The second volume 243 is separated from the first volume 214 by the impermeable walls of the internal pouch 241. Like the outer pouch 222, the internal pouch 241 may be made of any suitable food-safe material or combination of materials, such as polyethylene, polypropylene, metal foil, or the like.

The internal pouch 241 is coupled to the outer pouch 222 at a valve assembly 245 located at an end 247 of the package 210. The valve assembly 245 includes a rotatable inner member 249 that is rotatable to selectively establish fluid communication between the first volume 214 and the second volume 243. Thus, the valve assembly 245 is actuatable to start and stop a brewing process within the package 210.

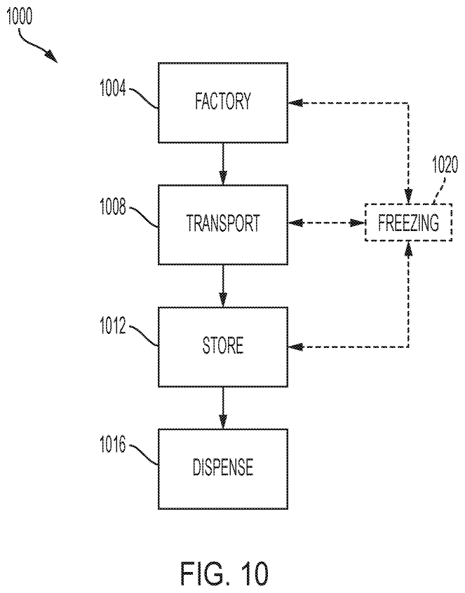

FIG. 10 illustrates a method 1000 for controlling a beverage brewing process according to some embodiments of the disclosure. The illustrated method 1000 includes first enclosing the brewing material and the liquid diluent in a sealed, disposable product package (such as any of the packages 10, 110, 210 described above) at step 1004. The packages 10, 110, 210 maintain the diluent and the brewing material in separate fluid-tight volumes until it is desired to initiate a brewing process.

At step 1008, the disposable product packages (e.g., 10, 110, 210) are shipped from the factory. In some embodiments, at step 1012, the product packages may be stored in a warehouse for a period of time before and/or after shipping at step 1012. Because the brewing material and the diluent can remain separated, the product packages need not be refrigerated to maintain freshness. This significantly lowers the cost and complexity of transporting and storing the product packages.

Finally, at step 1016 the product packages are received by an end user. In some embodiments, the product packages may be configured to interface with a dispenser. For example, the quick connect fitting 62 on the package 10 described above with reference to FIGS. 2 and 3 can be coupled to a corresponding fitting on the dispenser to fluidly couple the first volume 14 of the package 10 with the dispenser. This allows the contents of the package 10 to be dispensed without needing to first empty the package 10 into an external reservoir, which enhances efficiency and facilitates cleaning the dispenser.

The unique constructions of the packages 10, 110, 210 allow for brewing to take place within the packages during any one or more of the steps 1004, 1008, 1012, 1016 of the method 1000. For example, the end user may start and stop the brewing process in the packages 10, 110, 210 before dispensing. Alternatively, brewing may be started and stopped at the factory, during transport, and/or in storage, and can be interrupted one or more times during the method 1000 as desired. With continued reference to FIG. 10, once brewing is complete, the packages 10, 110, 210 can be refrigerated or frozen at step 1020 to maintain freshness, and/or to interrupt the brewing process at a selected time or stage of brewing. Because the packages 10, 110, 210 are preferably disposable and in some embodiments, interchangeable, they are convenient and efficient for the end user to receive and use.

In some alternative embodiments, the brewing material and the diluent may immediately mix within the package and begin brewing at the factory. In such embodiments, the product packages may be frozen at step 1020 to stop the brewing process once a desired brewing period has elapsed.

Thus, the method 1000 provides various means for controlling the start, end, and/or duration of the brewing process within the product packages during transportation or storage of the product packages.

Although the disclosure has been described in detail with reference to certain preferred embodiments, variations and modifications exist within the scope and spirit of one or more independent aspects of the disclosure as described. For example, although the illustrated embodiments utilize an concentric or inner/outer configuration between a first volume housing brewing material and a second volume housing diluent, it will be appreciated that the first and second volumes can be arranged in other manners with respect to one another while still enabling a user to begin and/or interrupt brewing within the disposable package by opening and/or closing fluid communication between the first and second volumes. For example, the first and second volumes can be defined by interior portions of the package 10, 110, 210 that are located on opposite sides of the package 10, 110, 210, opposite ends of the package 10, 110, 210, or in any other separate parts of the package 10, 110, 210. In such cases, any of the rotatable, slidable, frangible, or other structures disclosed herein that establish and/or stop the fluid communication between the volumes can be used, and fall within the spirit and scope of the present invention.

Various features of the invention are set forth in the following claims.

1. A product package comprising:
a first volume at least partially filled with a liquid diluent;
a second volume containing a brewing material; and
a valve moveable from a first position, in which the valve permits fluid communication between the first volume and the second volume to expose the brewing material to the liquid diluent, to a second position in which the valve inhibits fluid communication between the first volume and the second volume, and
wherein the product package is configured as a single-use disposable package.

2. The product package of claim 1, further comprising a first container at least partially defining the first volume and a second container at least partially defining the second volume, the second container extending into the first container such that the second container is at least partially surrounded by the liquid diluent in the first volume.

3. The product package of claim 2, wherein the second container includes an inner housing and an outer housing surrounding the inner housing, and wherein the inner housing defines the second volume.

4. The product package of claim 3, wherein the valve includes a window formed in the outer housing and an opening formed in the inner housing.

5. The product package of claim 4, wherein the opening is selectively alignable with the window by moving the inner housing relative to the outer housing to selectively fluidly communicate the first volume with the second volume.

6. The product package of claim 3, wherein the inner housing is rotatable relative to the outer housing.

7. The product package of claim 5, further comprising a screen covering at least one of the window or the opening, wherein the screen is configured to inhibit particles of the brewing material larger than a predetermined size from entering the first volume.

8. The product package of claim 1, wherein the valve is configured to fluidly communicate the first volume with the second volume in response to inverting the product package.

9. The product package of claim 8, wherein the valve includes a valve member that is buoyant in the liquid diluent.

10. The product package of claim 2, wherein the first container is configured as a flexible pouch.

11. The product package of claim 2, wherein the second container is configured as a rigid cartridge assembly.

12. The product package of claim 2, wherein an end of the second container is accessible from an exterior of the product package.

13. The product package of claim 2, further comprising an actuator accessible from an exterior of the product package, wherein the valve is configured to selectively fluidly communicate the first volume with the second volume in response to movement of the actuator.

14. (canceled)

15. The product package of claim 1, wherein the liquid diluent includes water, and wherein the brewing material includes ground coffee.

16. A method of controlling a brewing process within a single-use product package, the method comprising:
packaging a liquid diluent in a first volume of the package;
packaging a brewing material in a second volume of the package blocked from fluid communication with the first volume by a valve;
after packaging the liquid diluent and brewing material, establishing fluid communication between the first and second volumes by moving the valve to a first position to expose the brewing material to the diluent;
brewing a beverage by exposing the brewing material to the diluent;
after brewing for a predetermined time period, moving the valve to a second position to inhibit further fluid communication between the first and second volumes;
dispensing the brewed beverage from the package; and
after dispensing, discarding the product package.

17. (canceled)

18. The method of claim 16, wherein the predetermined time period is between about 10 hours and about 24 hours.

19. (canceled)

20. The method of claim 16, wherein establishing fluid communication between the first and second volumes includes moving an inner housing defining the second volume relative to an outer housing surrounding the inner housing.

21. The method of claim 20, wherein establishing fluid communication between the first and second volumes includes rotating the inner housing relative to the outer housing to at least partially align an opening in the inner housing with a window in the outer housing.

22. The method of claim 21, wherein at least one of the opening or the window includes a screen configured to prevent particles of the brewing material larger than a predetermined size from entering the first volume.

23. The method of claim 16, wherein establishing fluid communication between the first and second volumes includes moving a valve element.

24-30. (canceled)
